(19) United States
(12) Patent Application Publication
(10) Pub. No.: US 2013/0080962 A1
(43) Pub. Date: Mar. 28, 2013

(54) TOUCH SCREEN ALPHA NUMERIC KEYBOARD

(71) Applicant: Mahmoud Razzaghi, Chula Vista, CA (US)

(72) Inventor: Mahmoud Razzaghi, Chula Vista, CA (US)

(21) Appl. No.: 13/244,940

(22) Filed: Sep. 26, 2011

(51) Int. Cl. G06F 3/048

(52) U.S. Cl. 715/773

(57) ABSTRACT

A touch screen text input system comprising an alphabet keyboard, a row of numeric keys, a text box to show the entered characters, and a word suggestion box. The numeric row and the word suggestion box share the same location and are displayed interchangeably as needed.

The row of numeric keys is displayed by default and remains displayed as long as the user enters a numeric key or a combination of numeric and alphabet keys.

When the user first enters one or more alphabet keys, the numeric row is replaced by the word suggestion box. After the user completes typing a word by touching the space key or selecting a word from the word suggestion box, the numeric row replaces the word suggestion box.

### FIELD OF THE INVENTION

This invention relates to touch screen text input and virtual keyboards for computers, cell phones, and electronic devices.

### BACKGROUND OF THE INVENTION

In the relatively small cell phone virtual keyboard, the minimum key size requirement in relation to finger size limits the number of keys. Therefore, alphabet and numeric keys are provided in separate keyboards. The user must toggle between the two alphabet and numeric keyboards, which reduces typing speed.

Some virtual keyboards use one key to input multiple characters. However, the arrangement requires special attention and longer touch time to select the additional characters. Besides, due to lack of space, the size of characters displayed on the keys becomes too small for easy viewing.

### OBJECTS OF THE INVENTION

Therefore, the object of the invention is to provide a touch screen text input system with the following improvements:
1. Provide independent numeric keys on same virtual alphabet keyboard essentially without taking additional space or compromising the space for finger touch.
2. Improve typing speed by eliminating the need to switch between keyboards for typing alphabet or numeric characters.

### DESCRIPTION OF THE DRAWINGS

FIG. 1 shows a view of the embodiment of the invention with the numeric keys displayed in place of a word suggestion box.

FIG. 2 shows a view of the embodiment of the invention with the numeric keys replaced by a word suggestion box.

### BRIEF DESCRIPTION OF THE INVENTION

A touch screen text input system comprises a keyboard displaying an alphabet keyboard, a row of numeric keys, a text box to display the inputted characters and a word suggestion box. The numeric row and the word suggestion box share the same location and are displayed interchangeably as needed.

When the user first touches a numeric key, the respective character is entered in the text box. The row of numeric keys is displayed until the user touches the space key followed by at least one alphabet key. Then, the word suggestion box replaces the numeric row.

When the user first touches an alphabet key, the respective character is entered in the text box and the numeric row is replaced by the word suggestion box. The word suggestion box is displayed until the user completes typing a word by touching the space key or selecting a word from the word suggestion box. Then, the numeric row replaces the word suggestion box.

### DETAILED DESCRIPTION OF THE INVENTION

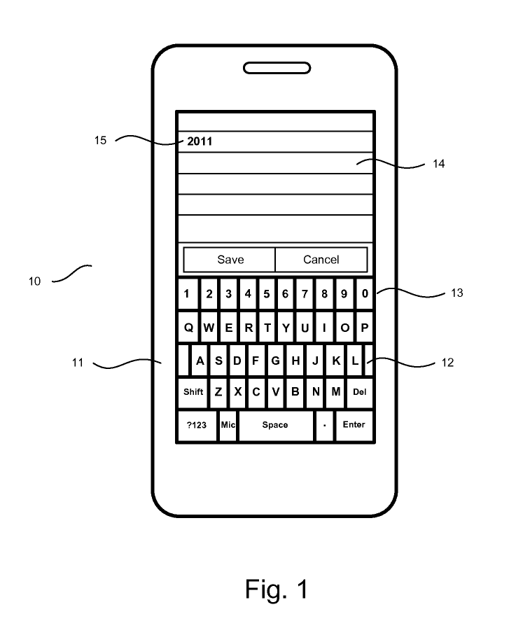

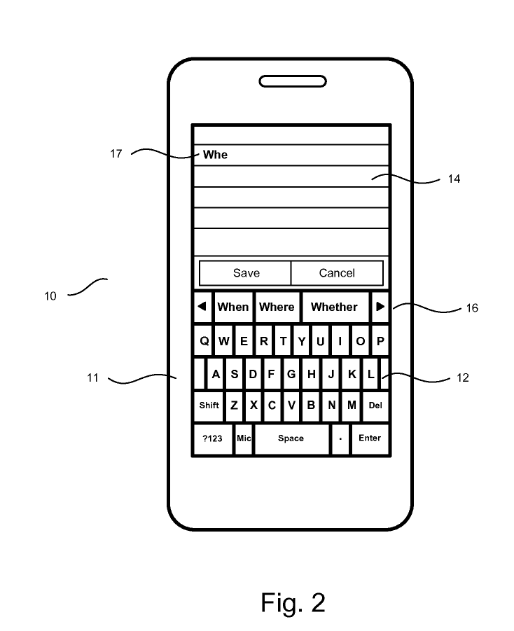

According to FIG. 1 and FIG. 2, there is a cell phone 10 with touch screen 11. Touch screen 11 displays virtual keyboard 12 including a row of numeric keys 13. Text box 14 displays key characters touched by the user.

When the user first touches a numeric key, the respective character is entered in text box 14 as text 15. Numeric row 13 is displayed until the user touches the space key followed by an alphabet key. Then, word suggestion box 16 replaces numeric row 13. Respective alphabet characters are entered both in text box 14 as text 17. Additionally, text 17 and suggested words beginning with text 17 are displayed in word suggestion box 16. Word suggestion box 16 is displayed until the user completes typing a word by touching the space key or selecting a word from word suggestion box 16. Then, numeric row 13 replaces word suggestion box 16.

When the user first touches an alphabet key, the respective character is entered in text box 14 as text 17. Also, word suggestion box 16 replaces numeric row 13. Additionally, text 17 and suggested words beginning with text 17 are displayed in word suggestion box 16. Word suggestion box 16 is displayed until the user completes typing a word by touching the space key or selecting a word from word suggestion box 16. Then, numeric row 13 replaces word suggestion box 16.

Word suggestion is useful usually when at least three characters are entered. Therefore, it may be preferable to replace numeric row 13 after touching two or three alphabet keys. This allows entering letter and number combinations starting with one to three letters.

The principle of the invention can also be used in larger touch screens.

I claim:

1. A touch screen text input system for cell phones, computers, and electronic devices, comprising:
a touch screen integrated with a cell phone or computer,
the touch screen has a virtual keyboard, a text box to display the text inputted through the virtual keyboard, and a word suggestion box to suggest different words based on initial user input,
the virtual keyboard is an alphabet keyboard with a numeric row of numbers 0 to 9,
the numeric row and word suggestion box share the same location and are displayed interchangeably as needed,
when the user first touches a numeric key, the respective character is entered in the text box, the row of numeric keys is displayed until the user touches the space key followed by at least one alphabet key, then, the word suggestion box replaces the numeric row, the word suggestion box is displayed until the user completes typing a word by touching the space key or selecting a word from the word suggestion box, then, the numeric row replaces the word suggestion box.
when the user first touches an alphabet key, the respective character is entered in the text box, the word suggestion box replaces the numeric row, the word suggestion box is displayed until the user completes typing a word by touching the space key or selecting a word from the word suggestion box, then, the numeric row replaces the word suggestion box.
